(19) United States
(12) Patent Application Publication
(10) Pub. No.: US 2011/0032698 A1
(43) Pub. Date: Feb. 10, 2011

(54) UNITED REFLECTION LIGHTS WITH LIGHT-EMITTING DIODE

(75) Inventor: Young Hun Kim, Daejeongwangyeok-si (KR)

Correspondence Address: SEED INTELLECTUAL PROPERTY LAW GROUP PLLC, 701 FIFTH AVE, SUITE 5400, SEATTLE, WA, 98104, US

(73) Assignee: U.R. Tech Corporation, Chicago, IL (US)

(21) Appl. No.: 12/536,415

(22) Filed: Aug. 5, 2009

(51) Int. Cl. F21V 5/00

(52) U.S. Cl. 362/235

(57) ABSTRACT

The present invention relates to a United Reflection Lights with Light-Emitting Diode (LED). In accordance with the present invention, the United Reflection Lights with LED consists of a housing; LED light sources which are installed with an inclination angle to the opposite inside wall of the housing and emit rays in forms of dots to the inside of the housing; and a reflecting plate which, placed in the bottom of the housing, reflect asymmetrically the incident rays originated from the above LED light sources with a number of triangle-shaped projecting parts and act as an indirect lighting device as it lets each of the above mentioned asymmetrically reflected rays combine and go to an intended direction in the form of a plane light source. The surface of the reflecting plate is covered with high polished synthetic resin. The reflecting plates vary according to at least one of the factors, whereby the plates become inter-changeable, such as the number or size of the projecting parts, the forming angle and the space between each projecting part.

In accordance with the present invention, the United Reflection Lights with LED enhances the efficiency of lighting and minimizes the energy consumption because all the rays, originally in forms of dots, are asymmetrically reflected on the reflecting plate and combined to emit in a formation of a plane light. The United Reflection Lights with LED can be adapted to indoor lamps such as fluorescent lamps and to all the outdoor lamps such as street lamps because it needs only a few LEDs whereby its structure can be simple and the cost decreases and also because its indirect lighting method minimizes the radiance. It can enhance the diffuse-ability of rays to the arrangement or longitudinal direction of a projecting part of the reflecting plate by controlling the angle of LED arrangement or forming the projecting part. Also it prevents the LEDs from the damage caused from heat by cooling the rising temperature of the circuit board with the reflecting plate functioning as a radiator.

### BACKGROUND OF THE INVENTION

1. Field of the Invention

The present invention relates to a united reflection lights with light-emitting diode (LED) that reflects asymmetrically each ray of incident light formed as dots and outputs the rays combined through the reflection in a formation of a plane light source.

2. Description of the Related Art

For general lighting equipments, halogen lamps are popular, which are incandescent lamps in which a tungsten filament is sealed into a compact transparent envelope filled with an inert gas and a small amount of halogen such as iodine or bromine. These halogen lamps are used as special lightings for paintings or pictures and for general lighting purposes in many shops and showrooms. However, these lamps have sticky points in that they consume a large amount of electricity, they emit heat that makes the surface of the reflected materials discoloured and increases room temperature in summer to worsen the consumption of electricity and they can not produce the lights of various colours.

To avoid these problems, LED (Light Emitting Diode, ‘LED’ shall represent it hereinafter) is popularly used in the field of lighting lamps recently.

The LED is a photoelectric transformation element consisting of a chip of semiconducting material impregnated with the n-side, whose major carrier is the electron, and the p-side, whose major carrier is the hole. The LED uses the lights naturally emitted when the electrons and holes, which are flowed in for the p-n junction, recombine.

LEDs emit a small amount of heat due to its power consumption of as low as 5W because they are efficient at photoelectric transformations. Because LEDs do not need preheating stages and they are not a type of heating or discharging lighting lamps, their lead time of lighting on and off is fast.

Also, LEDs, being made without any gas or filament, are difficult to damage with external shock and, using constant direct current power supplies, produce more light per watt than incandescent bulbs and can make high pulse repetition which reduces the optic nerves' fatigue of the users. LEDs have a semi permanent durability and can emit lights of various intended colours. LEDs can be very small as they need a small light source.

However, in case the of conventional use of LEDs which are point sources as lightings, when it is used for lighting purposes, there have been problems of high cost due to a lot of LEDs needing to be equipped in order to enhance the efficiency of lightings. This may cause to shorten the lifecycle of LEDs because of the heat generated when each LED, set in closely, is turn on, requiring maintenance procedures.

And, LED is basically not suited to lighting purposes because its high luminance, being lit directly on to human eyes, makes effulgence. To avoid this, a separate light guide plate has been used. However, it has caused other problems in that it decreases efficiency as a light source because the light guide plate diffuses and absorbs rays of light and that it makes the structure complicated.

### SUMMARY OF THE INVENTION

### 1. The Problems to be Solved

The present invention is designed to solve the existing problems listed above. An object of the present invention is to provide a united reflection lights with LED that enhances the efficiency of lighting and minimizes the energy consumption by minimising the loss of light when all the rays, originally in forms of dots, are asymmetrically reflected on the reflecting plate and combined to emit in a formation of a plane light.

Another object of the present invention is designed to provide a united reflection lights with LED that has the lighting function which enables it to be adapted to indoor lamps such as fluorescent lamps and to all the outdoor lamps such as street lamps because it needs only a few LEDs whereby its structure can be simple and the cost decreases and also because its indirect lighting method minimizes the radiance.

The other object of the present invention is to provide a united reflection lights with LED that, by managing the angle of the arranged position of LEDs or by forming different numbers of the projecting parts, can enhance the diffuse-ability of rays to the direction through which the projecting parts are arranged or to the longitudinal direction of the projecting parts of the reflecting plate.

The other object of the present invention is to provide a united reflection lights with LED that prevents the LED and circuit board from the damage caused from heat by cooling the rising temperature of the circuit board in which LEDs are installed, with the reflecting plate functioning as a radiator.

### 2. Technical Solution

To achieve the above objectives, a character of the present invention consists of a housing; a number of LED light sources which are installed with an inclination angle to the opposite inside wall of the housing and emit rays in forms of dots to the inside of the housing; and a reflecting plate which, placed in the bottom of the housing, reflect asymmetrically the incident rays originated from the above LED light sources with a number of triangle-shaped projecting parts and act as an indirect lighting device as it lets each of the above mentioned asymmetrically reflected rays combine and go to an intended direction in the form of a plane light source. The surface of the reflecting plate is covered with high polished synthetic resin. The reflecting plates vary according to at least one of the factors, whereby the plates become inter-changeable, such as the number or size of the projecting parts, the forming angle and the space between each projecting part.

Another character of the present invention is that the above mentioned reflecting plate has both ends being flat from the projecting part formed in the central area as a base point.

The other character of the present invention is that the above mentioned LED light sources, which installed at both ends from the above mentioned projecting parts as the base point, are placed on a slant which directs the originating lights to the centre of the projecting parts.

Also the other character of the present invention is that the surface of the above mentioned reflecting plate shall be compositely plated with at least one or more of two materials among the following: Chrome (Cr), Silver (Ag), Aluminium (Al), Gold (Au), Zinc Sulphide (ZnS), Nickel (Ni), Chromate Zinc (Zn), Tin (Sn), Rhodium (RHODIUM), Alloy which includes Brass, Nickel-Iron, Tin-Nickel or Lead-Tin Alloy, Platinum, Monel Metal and Cadmium (Cd).

### 3. The Effect of the Invention

In accordance with the present invention, the United Reflection Lights with LED enhances the efficiency of lighting and minimizes the energy consumption because all the rays, originally in forms of dots, are asymmetrically reflected on the reflecting plate and combined to emit in a formation of a plane light. The United Reflection Lights with LED can be adapted to indoor lamps such as fluorescent lamps and to all the outdoor lamps such as street lamps because it needs only a few LEDs whereby its structure can be simple and the cost decreases and also because its indirect lighting method minimizes the radiance. It can enhance the diffuse-ability of rays to the arrangement or longitudinal direction of a projecting part of the reflecting plate by controlling the angle of LED arrangement or forming the projecting part. Also it prevents the LEDs from the damage caused from heat by cooling the rising temperature of the circuit board, with the reflecting plate functioning as a radiator.

### BRIEF DESCRIPTION OF THE DRAWINGS

FIG. 1 is a schematic diagram illustrating the United Reflection Lights with LED of the present invention.

FIG. 2 is a drawing illustrating the principle how the rays from the LED light sources are asymmetrically reflected in the United Reflection Lights with LED.

FIG. 3 is a drawing illustrating the LED light sources which are placed differently to enhance the diffuse-ability of the reflected rays to the direction of Y axis in the United Reflection Lights with LED.

FIG. 4 is a drawing illustrating the reflecting plate of which the structure is modified to enhance the diffuse-ability of the reflected rays to the direction of X axis in the United Reflection Lights with LED.

### THE DETAILED DESCRIPTION OF THE INVENTION

Hereinafter, the united reflection lights with LED of the present invention will be explained in more detail with reference to the following examples.

Referring to an example of proper formation, the united reflection lights with LED of the present invention includes a housing(110), LED light sources(120) and a reflecting plate(130) and it is recommended that the whole unit should be formed as the same size as a conventional fluorescent lamp's.

In addition, the united reflection lights with LED(100) of the present invention can be used variously, ranging from a backlight module in LCD to lightings of indoors and outdoors.

The housing (110) is equipped with top and bottom sides that have outer walls, having a side opened. The LED light sources (120) and the reflecting plate (130) are fixed inside the housing. Terminals for electrifying the LED light sources (120) are equipped respectively on the both ends of the housing.

It is recommended that the size of the housing (110) should be the same as the conventional fluorescent lamp's when the united reflection lights with LED of the present invention is used as a substitute for the fluorescent lamp.

The LED light sources(120), which are light emitting diode lamps, will be placed, in a small number or large number, on the top of the inside wall of the housing(110) in opposite directions. When the projecting parts(132) of the reflecting plate(130) form linear, it is proper that a large number of LEDs should be placed in a linear form.

On this occasion, the LED light sources(120), started-on by the adjoining source of electricity, emit rays which form as dots to each projecting part (132) of the opposite reflecting plate (130).

The reflecting plate (130) is installed on the inside bottom of the housing (110) and has the projecting parts (132), arranged in every setting-up sequences of moulding or bending synthetic resin (including Acrylonitrile Butadiene Styrene copolymer) or aluminium panels, that reflect asymmetrically each ray of incident light, originated in forms of dots from the LED light sources (120), and to output the rays in a formation of a plane light source.

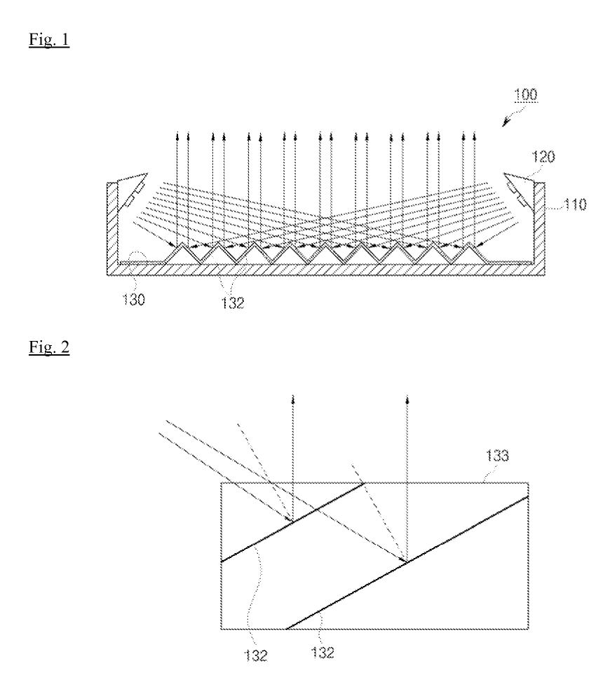

Referring to FIG. 2, the principle of the asymmetrical reflection is that the rays of incident light, originated in forms of dots from the LED light sources (120), are reflected asymmetrically through the reflecting plate (130) to the level surface (133) and combined to emit in perpendicular direction to the level surface (133) of the reflecting plate (130). In this process, the width of each ray of incident lights tends to widen when it is reflected and the rays, overlapped with the adjoining rays, are transformed and emitted in a formation of a plane light source.

In other words, the above reflecting plate (130) reflects the light originated from the LED light sources (120) asymmetrically by using the projecting part (132) and makes them go directly to the target object on the opposite direction to the level surface (133). That means, the incident light, which has a narrow width of the ray, from the LED light sources (120) becomes the reflected light, which has the wide width of rays, through the asymmetric reflection so that the light illuminates on the object.

On this occasion, because the light originated from the LED light sources (120) diffuses on the surface of the above reflecting plate (130), it is recommended that the surface should be highly polished as mirrors of which the surface have high intensity of illumination. For example, the surface shall be compositely plated with at least one or more of two materials among the following: Chrome (Cr), Silver (Ag), Aluminium (Al), Gold (Au), Zinc Sulphide (ZnS), Nickel (Ni), Chromate Zinc (Zn), Tin (Sn), Rhodium (RHODIUM), Alloy which includes Brass, Nickel-Iron, Tin-Nickel or Lead-Tin Alloy, Platinum, Monel Metal and Cadmium (Cd). The plating materials can be substituted and coatings, as another method, also may be applied to the surface. When the surface of the above reflecting plate(130) is plated with silver(Ag), the plate should be used after post-treatment.

When the reflecting plate(130) is made of metal materials or the surface is metal plated, the reflecting plate(130), functioning as a radiator, prevents the temperature of the united reflection lights with LED(100) from going up in the use of a long time period.

A change in character of asymmetric reflection can be easily obtained by just changing the plate with another because the above reflecting plate (130) is inter-changeable according to at least one of the factors such as the number or size of the projecting parts(132), the forming angle and the space between each projecting parts.

When the united reflection lights with LED (100) of the present invention is switched on, the LED light sources (120) light up and the rays from the sources start to emit sweepingly to the projecting parts (132) of the reflecting plate (130).

Some rays of incident light originated from the LED light sources (120) are reflected asymmetrically on each projecting part (132) and get combined with the other rays reflected on the level surface (133) of the reflecting plate (130) so as to go in a perpendicular direction. That is, the rays, originally in forms of dots, overlap and get emitted in the form of a plane.

In addition, the united reflection lights with LED has an advantage that it can be used as a substitute lighting for a conventional fluorescent lamp due to its size, when manufactured in same size, and due to its indirect lighting method that it reflects asymmetrically the rays of incident light, originated in forms of dots from the LED light sources (120), on the projecting parts (132) of the reflecting plate (130) so as to emit rays in the form of a plane, reducing radiance.

The above reflecting plate (130) prevents the LED light sources(120) from the damage caused from heat by cooling the rising temperature of inside of the united reflection lights with LED (100) because the reflecting plate functions as a radiator, extending the lifecycle of the LEDs.

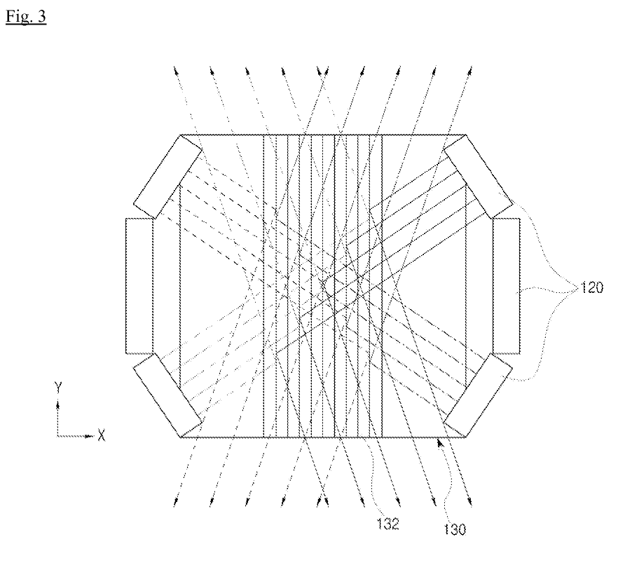

Referring to another example, as shown on FIG. 3, the above LED light sources (120), which are installed at the outlines of both ends of the projecting part(132) as the base point, are placed on a slant which directs the originating lights to the centre of the projecting parts so as to enhance the diffuse-ability of the rays to the direction of Y axis which is the longitudinal direction of the projecting parts(132).

Eventually, the rays, originated from the above LED light sources (120) which are installed at the inside lines of both ends of the projecting parts (132), combine perpendicularly to the bottom and the other rays, originated from the LED light sources (120) which are installed at the outlines of both ends of the projecting part (132), emit to the direction of Y axis which is the horizontal direction of the surface of the projecting parts (132). During this process, the diffuse-ability of the rays becomes higher so as to enhance the level of illumination.

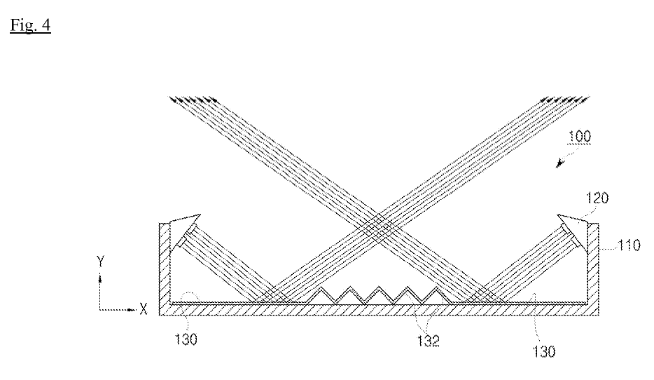

Moreover, as drawn on FIG. 4, the projecting part (132) can be formed completely differently from one part to the whole part of the reflecting plate (130). Alternatively, the remaining area of the both ends of the reflecting plate (132), after the projecting parts (132) are formed on the middle of it as the base point, are formed flat.

Since that the projecting parts (132) form partly on the middle of the reflecting plate (130) and the remaining parts of both ends are formed flat, some rays, originated from the above LED light sources (120), combine perpendicularly to the bottom by the projecting parts (132) and, simultaneously, the rest of the rays are reflected on the flat part of the reflecting plate (130) and go to the direction of X axis, the direction through which the projecting parts (132) are arranged. During this process, the diffuse-ability of the rays becomes higher so as to enhance the level of illumination.

Here before, the specific configuration and recommended operation of the present invention have been described in detail with reference to the examples accompanied. However, the protection scope of the invention is not limited to the above examples. The people with common knowledge of this technology field can understand that the present invention might be improved or modified as long as the modification does not exceed the principle and/or technical field of the invention.

What is claimed is:

1. A united reflection lights with LED, comprising;
a housing;
a number of LED light sources which are installed with an inclination angle to the opposite inside wall of the housing and emit rays in forms of dots to the inside of the housing;
a reflecting plate which, placed in the bottom of the housing, reflect asymmetrically the incident rays originated from the above LED light sources with a number of triangle-shaped projecting parts and act as an indirect lighting device as it lets each of the above mentioned asymmetrically reflected rays combine and go to an intended direction in the form of a plane light source, wherein the surface of the reflecting plate is covered with high polished synthetic resin, and the reflecting plates vary according to at least one of the factors, whereby the plates become inter-changeable, such as the number or size of the projecting parts, the forming angle and the space between each projecting parts.

2. The united reflection lights as claimed in claim 1, wherein both ends, from the projecting part formed in the central area on the reflecting plate as a base point, form flat.

3. The united reflection lights as claimed in claim 1, wherein the LED light sources, which installed at both ends of walls from the projecting part as the base point, are placed on a slant to the centre of the projecting parts.

4. The united reflection lights as claimed in claim 1, wherein the surface of the reflecting plate is compositely plated with at least one or more of two materials among the following: Chrome (Cr), Silver (Ag), Aluminium (Al), Gold (Au), Zinc Sulphide (ZnS), Nickel (Ni), Chromate Zinc (Zn), Tin (Sn), Rhodium (RHODIUM), Alloy which includes Brass, Nickel-Iron, Tin-Nickel or Lead-Tin Alloy, Platinum, Monel Metal and Cadmium (Cd).
